(19) United States
(12) Patent Application Publication
(10) Pub. No.: US 2012/0073612 A1
(43) Pub. Date: Mar. 29, 2012

(54) MOTOR FLUSHING APPARATUS AND SYSTEM

(76) Inventor: Gregory Wayne Maxwell, Queensland (AU)

(21) Appl. No.: 13/265,745

(22) PCT Filed: Apr. 22, 2010
(86) PCT No.: PCT/AU2010/000455

§ 371 Date: Dec. 6, 2011

(30) Foreign Application Priority Data
Apr. 22, 2009 (AU) 2009100369
Mar. 24, 2010 (AU) 2010100269

(51) Int. Cl. B08B 3/04; F01P 11/06; B08B 9/00

(52) U.S. Cl. 134/171; 134/22.1; 137/605

(57) ABSTRACT

A system and apparatus for use in flushing at least a portion of a motor with a cleansing fluid. A water inlet apparatus (10) and inlet (20) for flushing a boat motor with fresh water is provided and a system incorporating the apparatus (10) (and inlet 20) is also provided. In particular, the system and apparatus are used to flush a boat motor with fresh water after use. The apparatus has one or more inlets adapted to receive a fresh water source (e.g. a hose) and a valve, such as a diaphragm valve, that selectively allows flow of the fresh water into the motor instead of its usual water source (e.g. salt water). Preferably the valve is automatic and is actuated under pressure of the incoming fresh water. The inlet(s) are secured in a surface of the boat inside a basin, which may have a cover (optional) to protect the inlet(s) from the weather/elements.

### FIELD OF THE INVENTION

The invention relates to a motor flushing inlet and system. More specifically, the invention relates to a motor flushing inlet and system for use in flushing an in board boat motor, in particular heat exchangers, with fresh water.

### BACKGROUND ART

[Mere reference to background art herein should not be construed as an admission that such art constitutes common general knowledge in relation to the invention.]

Cooling systems in marine or boat motors typically intake water from the body of water that the motor is operated in. Where a boat motor is utilised in salt water, the cooling system of the boat motor therefore typically pumps salt water through the internal cavities of the motor for cooling purposes. For example, salt water is circulated through heat exchangers which extract heat generated from the motor through means of heat transfer from the internal workings of the motor to a medium such as salt water, and removes the excessive heat generated to stop the engine over heating. The flow of salt water can cause a build up of residual salt on the internal workings of the heat exchangers, and restricts heat transfer, thus causing the motor to build up excessive heat internally. This can cause large amounts of, if not catastrophic, damage to the engine. Furthermore, salt water is corrosive and can cause permanent damage to the internals of the cooling system and/or motor. In particular, a lot of corrosion occurs when the boat motor is off, and the water in the cooling system is stagnant. It is therefore desirable to flush the boat motor after use, to purge the salt water from the engine and replace it with less corrosive fresh water.

Unfortunately, flushing boat motors can be difficult and time consuming. External outboard boat motors may be flushed by running them in fresh water, or by utilise a provided a flushing system and/or procedure. However, internal inboard boat motors are not easily switched to a fresh water source, and are inherently more difficult to access. As a result, frequent chemical cleaning is often required of certain parts, such as the heat exchanges, to reduce corrosion and salt build up. This not only puts the motor out of service for a period of time, but is also expensive, time consuming, and the chemicals are generally bad for the environment.

It is an aim of this invention to provide a motor flushing system and/or water inlet device which overcomes or ameliorates one or more of the disadvantages or problems described above, or which at least provides a useful alternative.

### SUMMARY OF THE INVENTION

According to a first aspect of the invention, there is provided a system for flushing at least a portion of a motor with a cleansing fluid, the system comprising:

an inlet apparatus having a primary and a secondary inlet;

a cleansing fluid source connected to the secondary inlet during flushing for providing cleansing fluid to the inlet apparatus; and

a valve located adjacent or within the secondary inlet to selectively enable fluid flow between the cleansing fluid and the inlet apparatus.

Preferably the cleansing fluid is fresh water, and/or the inlet apparatus is a (fresh) water inlet apparatus. In a preferred embodiment, the motor is a boat motor.

The secondary inlet is preferably be configured to receive the fluid to be flushed through the motor in use. The valve preferably actuates to permit passage of the fluid upon receiving the fluid and/or connection of a conduit for the fluid to the inlet.

Typically, the water inlet apparatus is sealably engaged with, and in fluid communication with, a standard water inlet portion of the boat motor. The water inlet apparatus may be removably engaged with the standard water inlet. Typically, the primary inlet is utilised for water supply to the motor during normal motor operation, and the secondary inlet is utilised for water supply to the motor during flushing. The water inlet apparatus is preferably shaped to ensure water inlet to the motor is not impeded by the water inlet apparatus. For example, the primary inlet is preferably sized appropriately in relation to the secondary inlet, typically being larger in dimension than the secondary inlet.

According to another aspect of the invention, there is provided a motor inlet apparatus for switching between different fluid sources to a motor, the apparatus comprising:

a body portion having a primary inlet and an outlet, wherein the outlet is adapted to sealably engage with a standard fluid inlet portion on the motor;

a secondary inlet in fluid communication with the body portion; and

a valve adjacent or within the secondary inlet for selectively enabling fluid flow between the secondary inlet and the body portion.

In a preferred embodiment the motor is a boat motor, and preferably the fluid inlet portion is a water inlet portion. The apparatus is preferably configured to flush at least a portion of the motor with a cleansing fluid, the cleansing fluid preferably being water. Preferably the secondary inlet is configured to receive a fluid to be flushed through the motor. Preferably the valve actuates to permit passage of the fluid by receiving the fluid and/or by connection of a conduit for the fluid to the secondary inlet.

Preferably, the inlets have a circular cross section, and even more preferably the inlets are substantially cylindrical. The secondary inlet is preferably arranged at a distance from, or at an angle to, the primary inlet (e.g. the secondary inlet may be located in a surface away from the primary inlet, or may be perpendicular to the primary inlet). T

In a preferred embodiment, the motor is an inboard boat motor. The secondary inlet is preferably located on/in an outside surface of the boat. The secondary inlet may be a male or female connector, or any other suitable inlet, but in an embodiment is a male connector that receives at least a portion of a conduit (e.g. a hose with a corresponding female connector). The secondary inlet preferably sealably engages with the received portion of the conduit to ensure fluid communication between the conduit and the inlet without leaking of fluid at the join.

In a preferred embodiment the secondary inlet is recessed into a portion of the boat, preferably sufficiently recessed such that the male connectors do not protrude out of the surface. The apparatus may further comprise a basin within which the secondary inlet is located. Where the secondary inlet comprises a male connector, the basin is preferably at least as deep as the height of the connector mounted within the basin. The secondary inlet may be integral with the basin, or may be affixed, mounted, or attached to the basin.

The basin preferably provides protection and cover to at least an end portion of the secondary inlet when not in use. The basin may resemble the size and shape of a standard hawse hole, and may be fitted/mounted in a similar manner. Preferably the basin is made of a durable and corrosion resistant material. In an embodiment the basin is made of high quality 316 stainless steel.

More than one water inlet apparatus may be utilised, particularly where there are two or more elements of an motor to flush such as, for example, a twin engine boat, or a boat with one or more engines and generator, etc. Where more than one water inlet apparatus is utilised, there may be a plurality of secondary inlets (i.e. two or more). Preferably the plurality of secondary inlets will be adjacently arranged. One secondary inlet may also facilitate flushing of more than one element of a motor. For example, a single secondary inlet may be split to flush twin engines, or the like (however, it is anticipated an increase in pressure will be required to flush both engines simultaneously). The basin preferably contains (and protects) the plurality of secondary inlets.

The basin preferably has a rear wall having a plane substantially parallel to the plane of the surface that the basin is mounted within. The rear wall is preferably flat, and the secondary inlet(s) are preferably mounted in the rear wall. The basin preferably has side walls around the flat surface, the side walls preferably extending at least the height of the inlet connector(s). The basin may be mounted within a surface, such as the side of a boat, in the decking of the boat, or adjacent the engine of a boat, by cutting a hole in the surface approximately the size of the basin, inserting the basin into the hole, and then affixing the basin in the hole. The basin may have a flange that extends circumferentially around at least a portion of the side walls to facilitate fitting/mounting of the basin in the surface. The flange may have apertures for affixing members such as, for example, screws.

The secondary inlet(s) and/or basin may have a cover to protect the inlet(s) and basin when not in use. In a preferred embodiment the basin has a cover that is received by a portion of the basin when not in use. The cover preferably seals the inner volume of the basin from air and moisture (e.g. corrosive sea water and/or spray). The cover may have an affixing portion that is attached to the flange/basin, with a flexible or resilient portion that fits into an opening in the affixing portion. Preferably the cover is made of plastic, PVC and/or rubber and, in particular, be weather resistant. The cover may have a sealing member (e.g. a rubber gasket), or the like, to provide an air/water tight seal. The cover may have branding, instructions, advertising, or the like imprinted, embossed, stamped, and/or moulded into it (on the outer and/or inner surface).

In use, a source of cleansing fluid (preferably fresh water) is connected to the secondary inlet(s). During flushing, the valve may be manually or automatically actuated to allow the cleansing fluid to pass through the secondary inlet and out the outlet into the motor/engine for flushing. Preferably the valve is automatically actuated upon a fluid (e.g. water) being supplied to the secondary inlet, and/or upon a connector being attached to the secondary inlet. Preferably the valve is a diaphragm valve. Even more preferably, the diaphragm valve actuates upon receiving a predetermined pressure in the inlet.

In a preferred embodiment, when flushing the engine a water hose is connected to the secondary inlet and turned on, the increase in pressure actuates the diaphragm valve and permits fluid flow from the secondary inlet and out the outlet to the motor (or fluid circuit being cleansed). Upon finishing flushing, the pressure hose is turned off and removed from the inlet. The drop in pressure actuates the diaphragm valve to return to its usual closed state (permitting fluid flow through the primary inlet to the outlet, but not through the secondary inlet).

The inlets may be of any suitable size, but the primary inlet may have a diameter of approximately 10 to 100 mm. In an embodiment the primary inlet has a diameter of approximately 50 mm. The secondary inlet may be smaller, and in an embodiment has a diameter of approximately 20 mm.

Where the secondary inlet is at a distance from the primary inlet, a conduit, preferably a flexible conduit, may be utilised to fluidly connect the secondary inlet to the body containing the outlet (and, preferably, the primary inlet). The body containing the outlet may be a junction having two inlets (the primary and secondary inlets) and one outlet. In an embodiment the secondary inlet may comprise an inlet to the junction, or in another embodiment the secondary inlet may comprise an inlet fluidly connected to the junction by a conduit.

Where the secondary inlet is at an angle (e.g. perpendicular) to the primary inlet, the water inlet apparatus may be approximately 85 mm long. Preferably, the water inlet apparatus (and, in particular the junction) is made substantially from stainless steel, and even more preferably, 316 grade stainless steel. Other materials such as plastic may be used (particularly if the secondary inlet is at a distance from the primary inlet), but as the apparatus will typically be fitted substantially permanently, a durable material such as stainless steel is preferred, where possible. Unless otherwise specified, no limitation is intended in relation to the dimensions or materials described herein. The apparatus is typically capable of withstanding pressures of up to 6+ bar (85+ psi).

Preferably, the water inlet apparatus is sealably engaged with a standard water inlet portion on the boat motor. Even more preferably, the water inlet apparatus is an aftermarket addition to standard water inlet portions on boat motors, and the water inlet apparatus may also be removable. This allows a water inlet apparatus to be retrofitted to existing boats motors.

Preferably, the water inlet apparatus is engaged with the standard water inlet portion by fitting a portion of the water inlet apparatus into the standard water inlet pipe and fastening a hose clamp around the overlap to fixedly hold the water inlet apparatus with respect to the standard water inlet portion. Even more preferably, the portion of the water inlet apparatus at least includes the outlet. The water inlet apparatus may have a conduit connected to the primary and/or secondary inlets, which may be fastened in a similar manner. Preferably, the inlet(s) and/or the outlet have a circumferential ridge, or flange, to provide a tight fit between the water inlet apparatus and the overlap. The circumferential ridge, or flange, may also provide an abutment or anchor configuration against which a clamping means may hold, preferably preventing a conduit, such as a hose, from sliding free.

According to yet another aspect of the invention, there is provided a method for flushing at least a portion of a motor with a cleansing fluid, the method comprising the steps of:

connecting a cleansing fluid source to a secondary inlet that is in fluid communication with a boat motor inlet;

opening a normally closed valve between the secondary inlet and boat motor inlet;

flushing the motor with the cleansing fluid from the cleansing fluid source; closing the valve; and

disconnecting the cleansing fluid source from the secondary inlet.

Preferably the motor is a boat motor, and the cleansing fluid is water (even more preferably, fresh water). The step of connecting a cleansing fluid source may comprise connecting a conduit (preferably a hose). The secondary inlet is preferably in fluid communication with the valve, which is normally closed, and outputs (when open) to a (standard) boat motor inlet when actuated. Preferably the valve is actuated by fluid pressure in the inlet. The method may comprise the step of turning the fluid source on, which causes the valve to actuate, thereby allowing fluid to flow from the inlet and out of the now open valve into the boat motor inlet. Once the portion of the motor has been flushed, the method may comprise the step of turning the fluid source off (and/or disconnecting the fluid source from the inlet), which causes the valve to close, thereby preventing fluid to flow from the secondary inlet to the boat motor inlet.

Preferably, the step of flushing the motor with cleansing fluid is undertaken with the motor at idle. Typically, the method will further comprise the step of turning the motor on before flushing the motor, and turning the boat motor off after flushing the motor. Even more preferably, the boat motor is turned off directly after flushing the motor and before the valve is closed/actuated.

References to a boat motor may include all accessories and parts connected with, or utilised in, the operation of the motor. For example, a motor typically includes heat exchangers and sea strainers, and the flushing preferably purges water (e.g. salt water) and residues (e.g. salt) in the heat exchangers and/or other parts with a cleansing fluid, such as fresh water.

In order that the invention may be more readily understood and put into practice, one or more embodiments thereof will now be described, by way of example only, with reference to the accompanying drawings.

### BRIEF DESCRIPTION OF THE DRAWINGS

FIG. 1 illustrates a perspective view of a water inlet apparatus according to an embodiment of the invention.

FIG. 2 illustrates a side elevation view of a water inlet apparatus according to an embodiment of the invention.

FIG. 3 illustrates an exploded side elevation view of a water inlet apparatus according to an embodiment of the invention.

FIG. 4 illustrates an end side elevation view of a water inlet apparatus according to an embodiment of the invention.

FIG. 5 illustrates a top plan view of a water inlet apparatus according to an embodiment of the invention.

FIG. 6 illustrates a top perspective view of an inlet according to an embodiment of the invention.

FIG. 7 illustrates a top plan view of an inlet according to an embodiment of the invention.

FIG. 8 illustrates an underside perspective view of an inlet according to an embodiment of the invention.

FIG. 9 illustrates a top plan view of a cover for use with an embodiment of the invention.

FIG. 10 illustrates an inner perspective view of a cover for use with an embodiment of the invention.

FIG. 11 illustrates an outer perspective view of a cover for use with an embodiment of the invention.

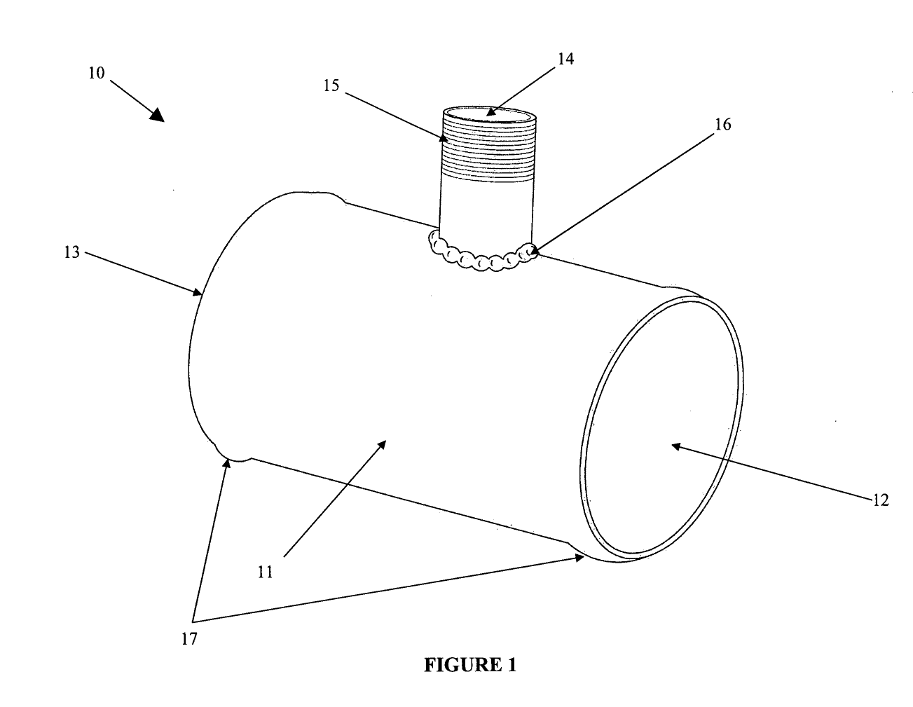

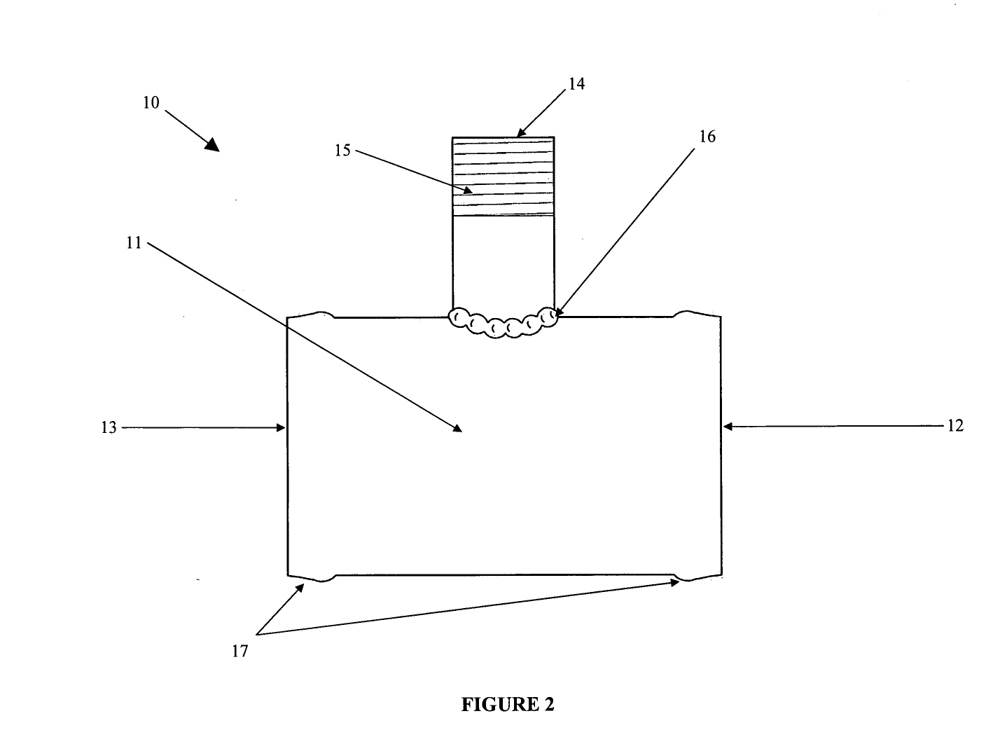

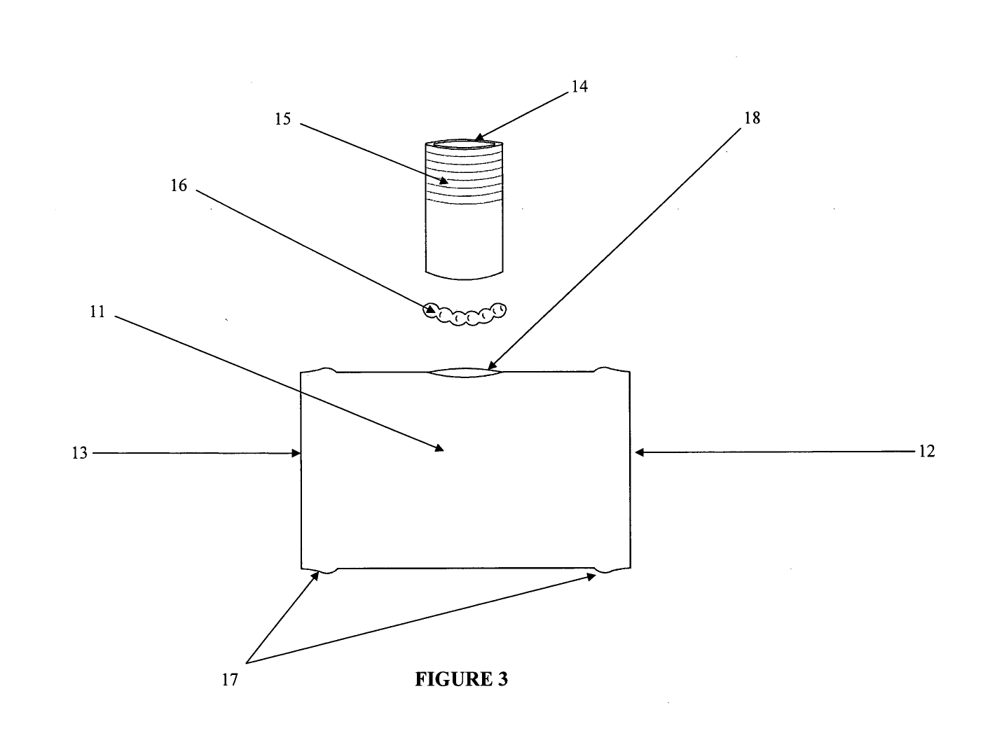

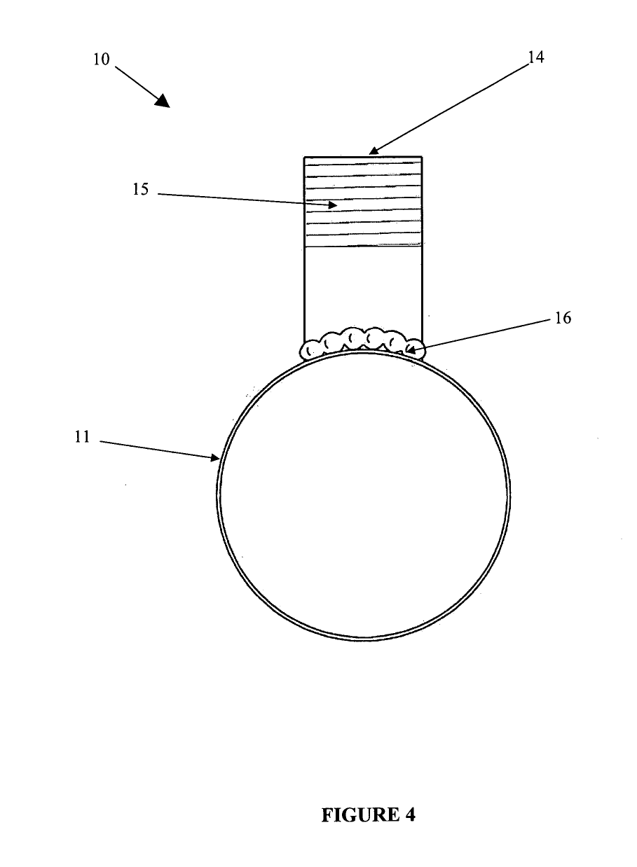

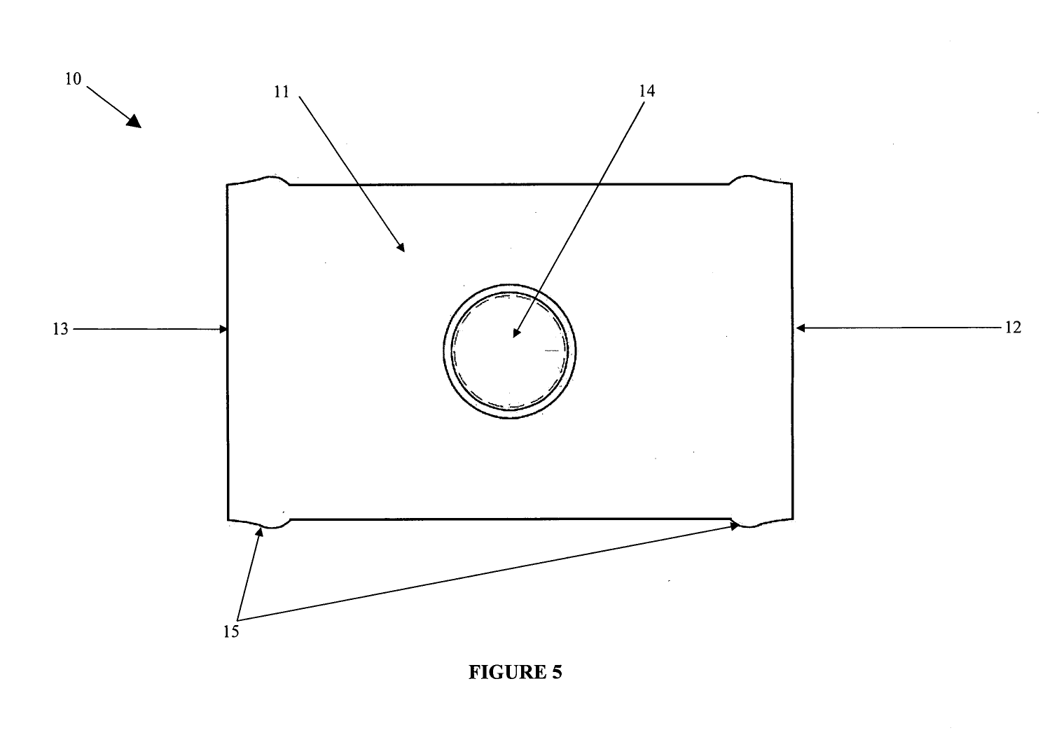

### DESCRIPTION OF PREFERRED EMBODIMENTS

Illustrated in the figures is a water inlet apparatus 10 having a substantially cylindrical body portion 11. At one end of the body portion 11 is a primary water inlet 12, and at the other end there is a water outlet 13. Perpendicularly disposed is a secondary inlet 14 which is in fluid communication with the body portion 11. The secondary inlet 14 has a threaded portion 15, and is affixed to the body portion 11 by a circumferential weld 16. A valve (not shown) is attached to the secondary inlet 14 via the threaded portion 15.

The water inlet apparatus 10 is easily installed inline with a standard water inlet portion of a boat motor (not shown) by fitting a portion of the water inlet apparatus 10 in to the standard water inlet portion and fastening a hose clamp (not shown) around the overlap to fixedly hold the water inlet apparatus 10 in place with respect to the standard water inlet portion. To facilitate the connection between the water inlet apparatus 10 and the standard water inlet portion, the body portion 11 of the water inlet apparatus 10 has a circumferential ridge 17. The ridge 17 not only provides a better seal between the water inlet apparatus 10 and the standard water inlet portion, but it also provides a raised portion against which the hose clamp can be fastened.

Then the boat motor is in use, the pressure in the standard water inlet portion is reduced such that water flows into the inlet and through the boat motor for cooling purposes. There is no change in this behaviour with the water inlet apparatus 10 installed, as when the boat motor is in use, water flows substantially unimpeded into the primary inlet 12 and out of the outlet 13 to the standard water inlet portion.

After use, the water inlet apparatus 10 can be utilised to flush the boat motor with fresh water. In order to do this, a fresh water source, such as a hose, is connected to the other side of the valve, and the valve is opened. The fresh water consequently flows in to the secondary inlet 14 and flushes the boat motor with fresh water. In particular, the heat exchangers are flushed while the motor is running at idle. When flushed, the motor is turned off, the valve is closed, and the water source is disconnected. The water cooled components of the motor are accordingly surrounded by fresh water after flushing. The fresh water remains in system the instead of salt water until further use, reducing corrosion to the motor, and the build up of salt. This prolongs the life of the motor, further reducing required maintenance and repairs to the salt water cooling system without the need for environmentally unfriendly chemicals.

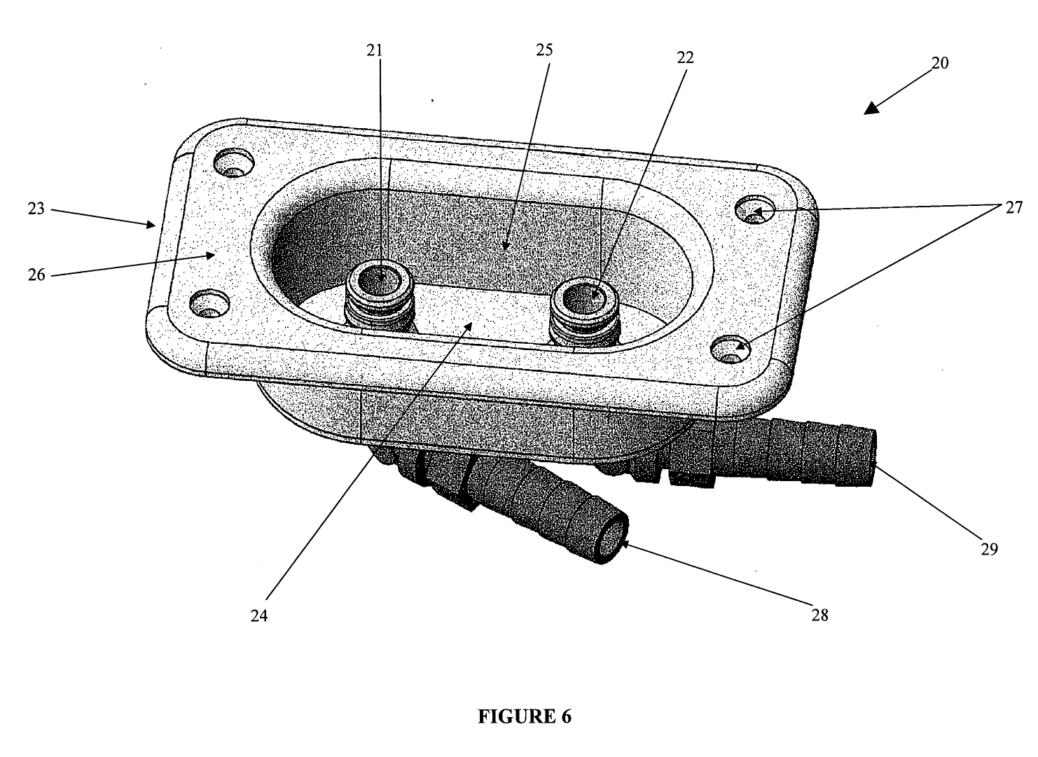

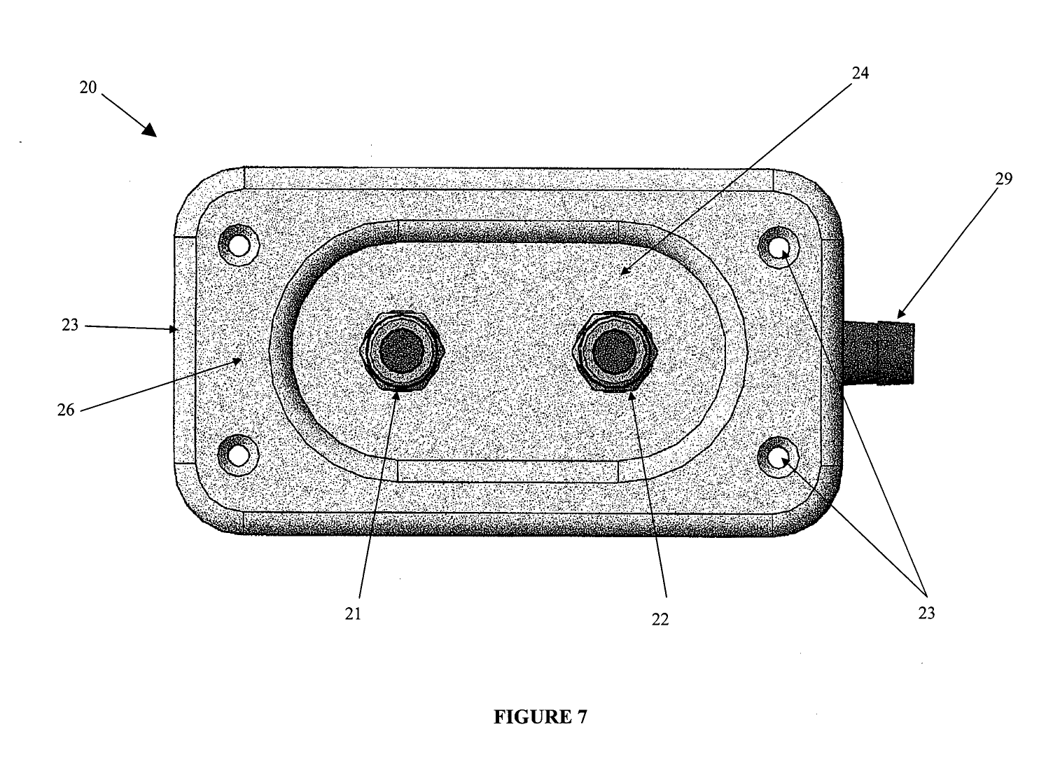

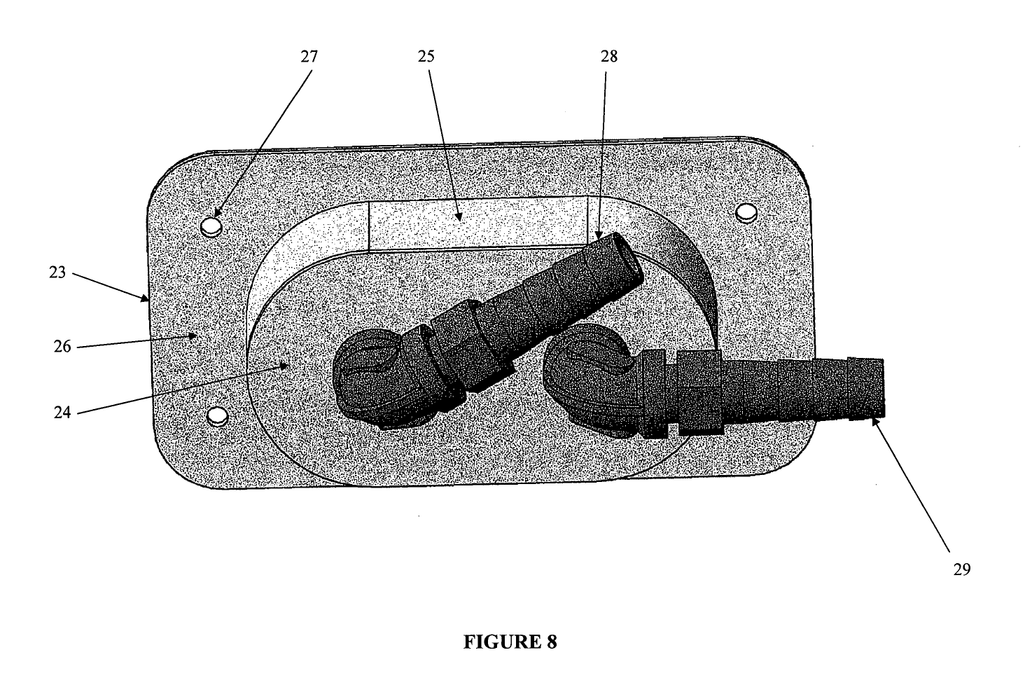

FIGS. 6 to 8 illustrate a secondary inlet portion 20 having two inlets 21 and 22 housed within a basin 23. The secondary inlet portion 20 is utilised in an embodiment where the secondary inlet is located at a distance from the body of the water inlet apparatus 10 (e.g. where the water inlet apparatus 10 is located at or near a boat motor, and the secondary inlet portion 20 is mounted in or in a surface of the boat readily accessible from the deck and/or a mooring). The inlets 21 and/or 22 of the secondary inlet portion 20 are in fluid communication with the secondary inlet 14 of the water inlet apparatus 10. In this regard, an inlet 21 or 22 effectively becomes the secondary inlet 14 of the apparatus, by extension of the conduit.

The inlets 21 and 22 may be in fluid communication with the secondary inlet 14 by a conduit, preferably a hose (not shown). The hose may be flexible (e.g. a flexible plastic or PVC hose) or may be rigid (such as a stainless steel or copper hose). With two inlets (e.g. 21 and 22), they are preferably each connected to a separate water inlet apparatus 10 to enable flushing/cleaning of separate motors and/or separate portions of one or more motors.

The inlets 21 and 22 comprise connectors, more particularly male connectors that can receive a corresponding (female) connecter thereon (not shown). The basin 23 has a flat rear wall 24 and a perpendicularly extending side wall 25. The side wall 25 is slightly higher than the connectors/inlets 21 and 22 so that they are protected safely therein. The connectors 21 and 22 are standard click-lock type connectors that sealably engage with corresponding ‘click on’ female connectors.

The basin 23 has a circumferential flange 26 with apertures 27 therein. In use, the basin 23 is fitted into a surface of the boat (not shown), much like a hawse hole is typically fitted, but preferably in a location where plumbing/piping behind the basin will be concealed. The apertures 27 of the flange 26 can receive fastening members, such as screws (not shown) to affix the basin 23 with inlets 21 and 22 into the boat.

The illustrated embodiment has hose connectors 28 and 29 extending behind the basin 23 from the inlets 21 and 22 (in the illustrated embodiment the hose connectors are generally perpendicular to the inlet to reduce the depth of the apparatus 20, but other shaped hose connectors, or conduits, may also be utilised). The hose connectors 28 and 29 allow a conduit, such as a flexible hose (e.g. a rubber hose) to be fitted thereon.

The inlet(s) 21 and/or 22 are connected via a valve, preferably a diaphragm valve (not illustrated) to inlet 14 of the water inlet apparatus 10. When the boat motor is in use, the pressure in the standard water inlet portion is reduced such that water flows into the inlet and through the boat motor for cooling purposes. There is no change in this behaviour with the water inlet apparatus 10 installed, as when the boat motor is in use, water flows substantially unimpeded into the primary inlet 12 and out of the outlet 13 to the standard water inlet portion of the boat motor, and the closed valve ensures no flow of fluid from the inlet(s) 21 and/or 22.

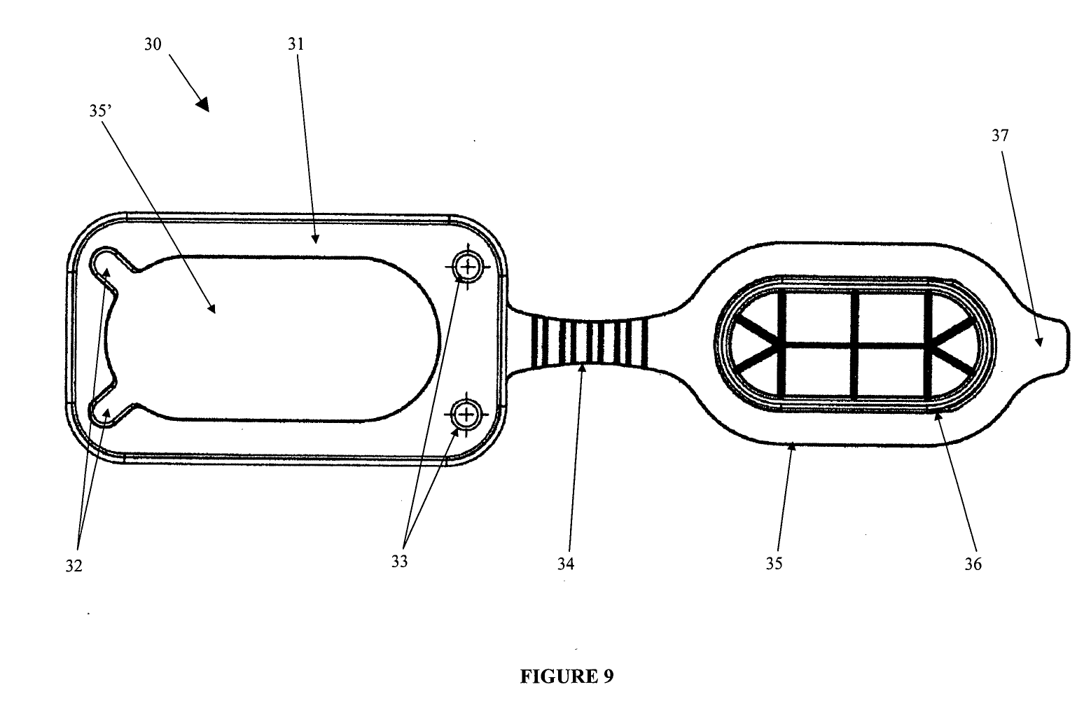

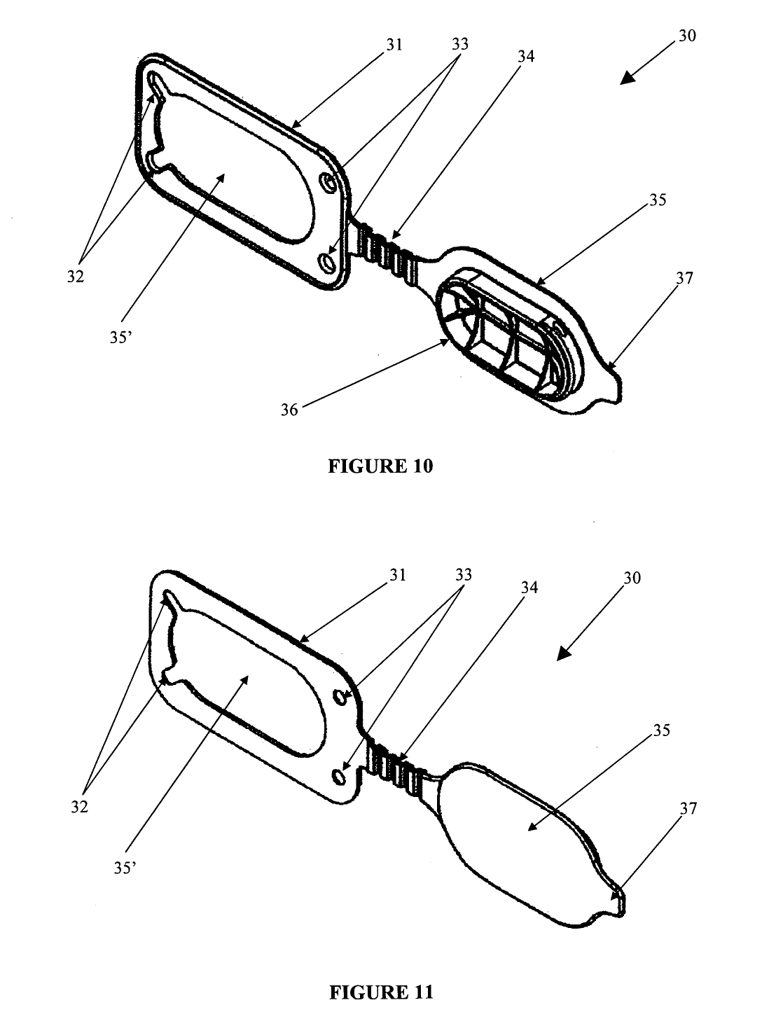

Illustrated in FIGS. 9 to 11 is a cover 30 that may be used to cover the opening in the basin 23, and provides protection to the inlets 21 and 22 from the weather/elements (e.g. salt spray). The cover 30 has an affixing portion 31 that is attached to the flange 26 of the basin 23. The affixing portion 31 of the cover 30 may be attached, affixed, or mounted to the basin 23 in any suitable manner, but in the illustrated embodiment it is affixed by having cut outs 32 and apertures 33 that align with the apertures 27 of the basin, such that when a fastening member is received therein, the affixing portion 31 of the cover 30 is held adjacent the outer surface of the basin 23 (in particular, the outer surface of the flange portion 26).

The cover 30 has a flexible or resilient portion 34 and a lid 35 that fits securely within the opening 35′ of the affixing portion 31 of the cover 30. To place the lid 35 in a covering position, the flexible/resilient portion 34 is folded such that an inner protruding portion 36 of the lid 35 is received by the opening 35′. The lid portion 35 of the cover 30 has a tab 37 that may be utilised for gripping, or the like, to assist in manoeuvring the lid portion 35, particularly when opening the cover 30 from a closed position.

When in an open position (as illustrated) the lid 35 is held in place by the flexible or resilient portion 34, and will not fall out or off the cover 30 (where it may have been damaged and/or lost). The protruding portion 36 is preferably shaped similarly to the opening 35′ to ensure a good seal between the lid 35 and the opening 35′ when in the closed position. The protruding portion 36 may also have a ridge that assists in holding the lid 35 within the opening 35′, when in the closed position.

After use of the boat motor, the inlet 20 and the water inlet apparatus 10 can be utilised to flush the boat motor with fresh water. In order to do this, the cover 30 is opened, and a cleansing fluid source, preferably a fresh water source (such as a hose), is connected to one or more of the inlets 21 and 22. The valve is opened manually or automatically, but in a preferred embodiment the valve is an automatically actuating diaphragm valve. The fresh water flows in the inlet 21 and/or 22, through the valve to the secondary inlet 14 of the inlet body 10, and flushes the boat motor with fresh water. In particular, the heat exchangers may be flushed while the motor is running at idle. When finished flushing the motor, the motor is turned off, the valve is closed (manually or automatically), the water source is disconnected, and the cover is closed.

After and during flushing, the water cooled components of the motor are surrounded with the cleansing fluid (typically fresh water). The fluid remains in the system instead of salt water until further use, reducing corrosion to the motor, and the build up of salt. This prolongs the life of the motor, further reducing required maintenance and repairs to the salt water cooling system without the need for environmentally unfriendly chemicals.

By flushing the motor and adding fresh water to the salt water side of the motor and, particularly the heat exchanger system, upon completion of a journey, salt build up and corrosion are greatly reduced. This provides many advantages, including improving fuel economy due to more efficient motor operation, and reducing the possibility of the motor overheating. Furthermore, the flushing also prolongs the life of the zinc anodes which are there to protect the internals of a motor from salt attack during use and non-use. Advantageously, the inlet apparatus may be a one off purchase, and is easily installed and utilised in pre-existing boats/motors/systems. As the inlets 21 and 22 are located conveniently within the basin 23 in a surface of the boat, they are easily accessible, and flushing of the motor (and/or other components) is carried out easily by simple connecting the fresh water source to one or more of the inlets 21 and 22.

It is to be understood that the terminology employed above is for the purpose of description and should not be regarded as limiting.

The foregoing embodiments are intended to be illustrative of the invention, without limiting the scope thereof The invention is capable of being practised with various modifications and additions as will readily occur to those skilled in the art.

Accordingly, it is to be understood that the scope of the invention is not to be limited to the exact construction and operation described and illustrated, but only by the following claims which are intended, where the applicable law permits, to include all suitable modifications and equivalents within the spirit and concept of the invention.

Throughout this specification, including the claims, where the context permits, the term “comprise” and variants thereof such as “comprises” or “comprising” are to be interpreted as including the stated integer or integers without necessarily excluding any other integers.

1. A system for flushing at least a portion of a motor with cleansing fluid, the system comprising:
an inlet apparatus having a primary and a secondary inlet;
a cleansing fluid source connected to the secondary inlet during flushing for providing cleansing fluid to the inlet apparatus; and
a valve located adjacent or within the secondary inlet to selectively enable fluid flow between the cleansing fluid source and the inlet apparatus.

2. A system as claimed in claim 1, wherein the inlet apparatus is a water inlet apparatus.

3. A system as claimed in claim 2, wherein the water inlet apparatus is sealably engaged with, and in fluid communication with, a standard water inlet portion of a boat motor.

4. A system as claimed in claim 3, wherein the water inlet apparatus is removably engaged with the standard water inlet.

5. A system as claimed in claim 1, wherein the primary inlet is utilised during normal motor operation, and the secondary inlet is utilised during flushing.

6. A system as claimed in claim 1, wherein the valve actuates to permit a passage of the fluid upon receiving the fluid and/or connection of a conduit for the fluid to the inlet.

7. A system as claimed in claim 1, wherein the cleansing fluid is fresh water.

8. A motor inlet apparatus for switching between different fluid sources to a motor, the apparatus comprising:
a body portion having a primary inlet and an outlet, wherein the outlet is adapted to sealably engage with a standard fluid inlet portion on the motor;
a secondary inlet in fluid communication with the body portion; and
a valve adjacent or within the secondary inlet for selectively enabling fluid flow between the secondary inlet and the body portion.

9. A motor inlet as claimed in claim 8, wherein the fluid inlet portion is a water inlet portion.

10. A motor inlet as claimed in claim 8, wherein the secondary inlet is configured to receive a fluid to be flushed through the motor.

11. A motor inlet as claimed in claim 8, wherein the valve actuates to permit passage of the fluid by receiving the fluid and/or by connection of a conduit for the fluid to the secondary inlet.

12. A motor inlet as claimed in claim 8, wherein the secondary inlet is configured to be affixed in a surface.

13. A motor inlet as claimed in claim 8, wherein the motor inlet comprises a connector for a conduit.

14. A motor inlet as claimed in claim 8, wherein the motor inlet comprises a basin within which the secondary inlet is located.

15. A motor inlet as claimed in claim 14, wherein the basin is configured to be recessed into a surface.

16. A motor inlet as claimed in claim 14, wherein the basin contains more than one secondary inlet.

17. A motor inlet as claimed in claim 14, further comprising a cover.

18. A motor inlet as claimed in claim 17, wherein the cover is received by a portion of the basin and seals the inner volume of the basin.

19. A motor inlet as claimed in 8, wherein the valve is automatically actuated.

20. A motor inlet as claimed in claim 19, wherein the valve is actuated by a pressure increase of a cleansing fluid source being connected to the secondary inlet.

21. A motor inlet as claimed in claim 20, wherein the cleansing fluid source is a fresh water hose.

22. A motor inlet as claimed in claim 19, wherein the valve is a diaphragm valve.

23. A motor inlet as claimed in claim 8, further comprising a flexible conduit to provide fluid communication between the secondary inlet and the body portion.

24. A motor inlet as claimed in claim 8, wherein the apparatus is capable of withstanding pressures of 6 bar or 85 psi.

25. A method for flushing at least a portion of a motor with a cleansing fluid, the method comprising the steps of:
connecting a cleansing fluid source to a secondary inlet that is in fluid communication with a boat motor inlet;
opening a normally closed valve between the secondary inlet and boat motor inlet;
flushing the motor with the cleansing fluid from the cleansing fluid source;
closing the valve; and
disconnecting the cleansing fluid source from the secondary inlet.

26. A method as claimed in claim 25, wherein the motor is a boat motor.

27. A method as claimed in claim 25, wherein the cleansing fluid is water.

28. A method as claimed in claim 25, wherein the step of connecting a cleansing fluid source comprises connecting a conduit to the secondary inlet.

29. A method as claimed in claim 28, wherein the conduit is a hose.

30. A method as claimed in claim 25, wherein the valve is actuated by fluid pressure in the secondary inlet.

31. A method as claimed in claim 25, wherein the steps are undertaken with the motor at idle.
